(19) United States
(12) Patent Application Publication
(10) Pub. No.: US 2020/0078876 A1
(43) Pub. Date: Mar. 12, 2020

(54) PORTABLE CUTTING MACHINE

(71) Applicant: MAKITA CORPORATION, Anjo-shi (JP)

(72) Inventors: Katsumi OKOUCHI, Anjo-shi (JP); Yoshihiro KIMURA, Anjo-Shi (JP); Hirotomo INAYOSHI, Anjo-shi (JP); Kenji HAMADA, Anjo-shi (JP)

(73) Assignee: MAKITA CORPORATION, Anjo-shi (JP)

(21) Appl. No.: 16/561,417

(22) Filed: Sep. 5, 2019

(30) Foreign Application Priority Data
Sep. 7, 2018 (JP) 2018-167909
Apr. 25, 2019 (JP) 2019-084160

(51) Int. Cl. B23D 45/16

(52) U.S. Cl. CPC B23D 45/16

(57) ABSTRACT

A portable cutting machine allows a large battery pack to be attached on the rear of a handle unit without largely increasing the height of the handle unit. A portable cutting machine to which a battery pack having a connecting surface is attachable includes a base that comes in contact with a workpiece, a cutting machine body supported on an upper surface of the base and including a cutting blade protruding from a lower surface of the base to cut the workpiece, an electric motor that drives the cutting blade, and a handle unit grippable by a user, and a battery attachment portion located opposite to the cutting blade with respect to the handle unit to receive the battery pack attachable by sliding in a posture with the connecting surface facing sideward.

### CROSS-REFERENCE TO RELATED APPLICATIONS

This application claims the benefit of priority to Japanese Patent Application No. 2018-167909, filed on Sep. 7, 2018, and Japanese Patent Application No. 2019-084160, filed on Apr. 25, 2019, the entire contents of which are hereby incorporated by reference.

### BACKGROUND

### 1. Technical Field

The present invention relates to a portable cutting machine powered by a rechargeable battery pack.

### 2. Description of the Background

Japanese Unexamined Patent Application Publication Nos. 2010-201598 and 2014-79812 each describe a portable cutting machine to which a battery pack as a power source is attachable. A known cutting machine, also referred to as a portable circular saw, is gripped on its handle and is moved forward, with its rectangular base in contact with the upper surface of a workpiece to be cut. A circular cutting blade protruding from the lower surface of the base then cuts into the workpiece to perform cutting.

A known cutting machine has an area for receiving a battery pack in a bottom space at the rear of a handle unit. The bottom space of the handle unit is used efficiently to save space for attaching the battery pack.

### BRIEF SUMMARY

However, larger battery packs have become common recently. A larger battery pack cannot fit in a bottom space at the rear of a handle unit. A large battery pack can easily interfere with a base, whereas a handle unit designed to have a larger height to avoid interference between the battery pack and a base can be gripped at a higher position more away from a cutting target, thus lowering the operability during cutting.

One or more aspects of the present invention are directed to a structure that allows a large battery pack to be attached on the rear of a handle unit without largely increasing the height of the handle unit.

An aspect of the present invention provides a portable cutting machine to which a battery pack having a connecting surface is attachable, the portable cutting machine comprising:
a base configured to come in contact with a workpiece;
a cutting machine body supported on an upper surface of the base, the cutting machine body including
   a cutting blade protruding from a lower surface of the base to cut the workpiece,
   an electric motor configured to drive the cutting blade, and
   a handle unit grippable by a user; and
a battery attachment portion located opposite to the cutting blade with respect to the handle unit, the battery attachment portion being configured to receive the battery pack attachable by sliding in a posture with the connecting surface facing sideward.

This structure allows a large battery pack to be attached on the rear of the handle unit without largely increasing the height of the handle unit.

### BRIEF DESCRIPTION OF DRAWINGS

FIG. 1 is an overall right side view of a portable cutting machine according to a first embodiment.

FIG. 2 is an overall plan view of the portable cutting machine according to the first embodiment as viewed in the direction of arrow (II) in FIG. 1.

FIG. 3 is an overall front view of the portable cutting machine according to the first embodiment as viewed in the direction of arrow (III) in FIG. 1.

FIG. 4 is an overall left side view of the portable cutting machine according to the first embodiment as viewed in the direction of arrow (IV) in FIG. 3.

FIG. 5 is an overall rear view of the portable cutting machine according to the first embodiment as viewed in the direction of arrow (V) in FIG. 1.

FIG. 6 is an overall right side view of the portable cutting machine according to the first embodiment with a cutting machine body placed at a high position to achieve a small cutting depth.

FIG. 7 is an overall left side view of the portable cutting machine according to the first embodiment with the cutting machine body placed at a high position to achieve a small cutting depth.

FIG. 8 is an overall left side view of the portable cutting machine according to the first embodiment with a battery pack detached.

FIG. 9 is a perspective view of the battery pack alone.

FIG. 10 is an overall left side view of a portable cutting machine according to a second embodiment.

FIG. 11 is an overall left side view of the portable cutting machine according to the second embodiment with a battery pack detached.

FIG. 12 is an overall right side view of a portable cutting machine according to a third embodiment.

FIG. 13 is an overall plan view of the portable cutting machine according to the third embodiment as viewed in the direction of arrow (XIII) in FIG. 12.

FIG. 14 is a cross-sectional view of the portable cutting machine according to the third embodiment taken along line (XIV)-(XIV) in FIG. 12.

FIG. 15 is an overall left side view of the portable cutting machine according to the third embodiment as viewed in the direction of arrow (XV) in FIG. 13.

FIG. 16 is a left view of the portable cutting machine according to the third embodiment showing its internal structure.

FIG. 17 is a cross-sectional view of the portable cutting machine according to the third embodiment taken along line (XVII)-(XVII) in FIG. 15.

FIG. 18 is an overall perspective view of the portable cutting machine according to the third embodiment as viewed in the direction of arrow (XVIII) in FIG. 15, or viewed from a ground contact surface for inverted placement in the plane direction.

FIG. 19 is an overall perspective view of the portable cutting machine according to the third embodiment standing upside down with the ground contact surface in contact with the ground.

### DETAILED DESCRIPTION

### First Embodiment

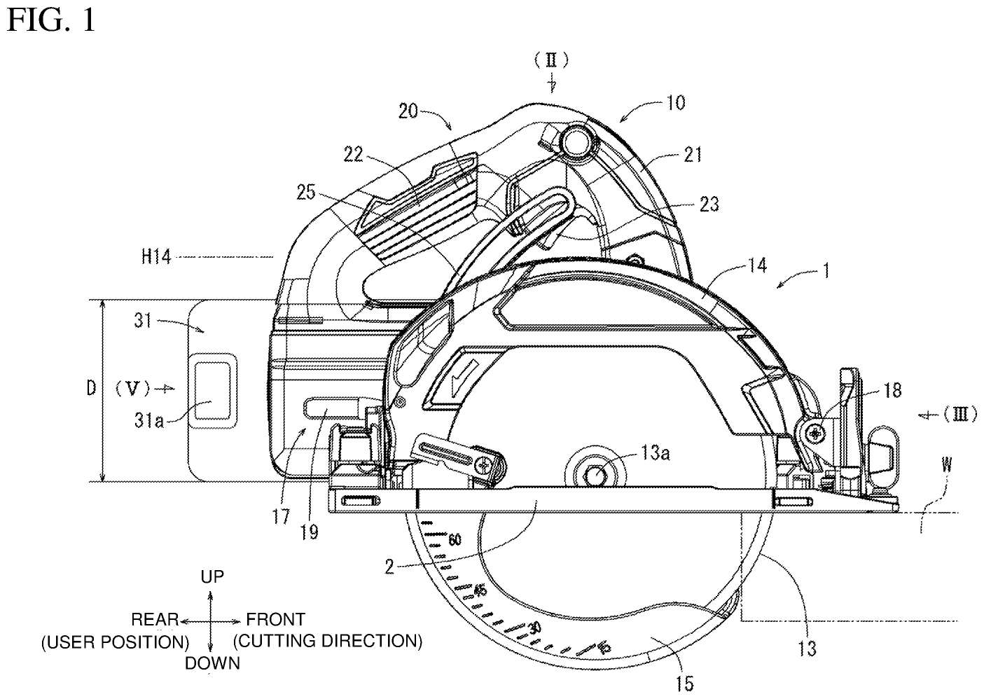

A portable cutting machine according to one or more embodiments will now be described with reference to FIGS. 1 to 19. FIGS. 1 to 5 show a portable cutting machine 1 according to a first embodiment. The portable cutting machine 1 according to the present embodiment is a portable circular saw. The portable cutting machine 1 includes a base 2 and a cutting machine body 10. The base 2, which is a rectangular flat plate, is placed in contact with the upper surface of a workpiece W. The cutting machine body 10 is supported on the upper surface of the base 2.

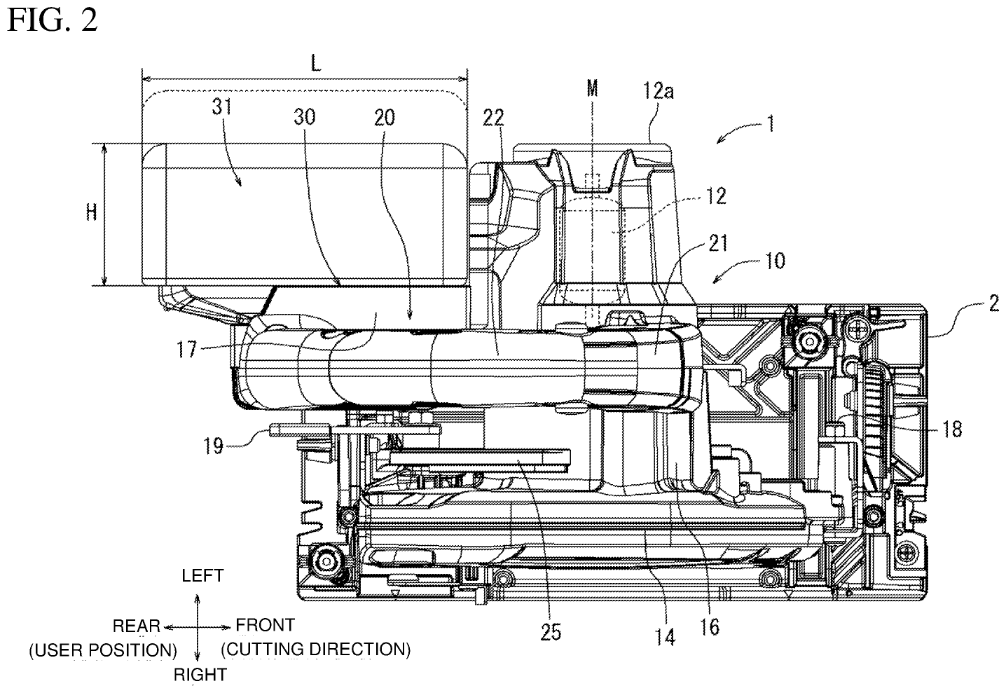

As shown in FIGS. 1 and 2, a user stays on the left of the portable cutting machine 1 and moves the portable cutting machine 1 rightward in FIGS. 1 and 2 to perform cutting. The components and structures will be described herein by referring to the front-rear direction with the front being the direction of cutting and the rear being where the user stays. Also, the right-left direction is defined as viewed from the user.

The cutting machine body 10 includes a circular cutting blade 13 called a tipped saw, which rotates using an electric motor 12 as a power source. The cutting blade 13 has an upper portion covered with a stationary cover 14. The cutting blade 13 has a lower portion protruding from the lower surface of the base 2. The lower portion protruding from the lower surface of the base 2 cuts into the workpiece W to perform cutting.

The cutting blade 13 has a lower edge (cutting edge) protruding from the lower surface of the base 2. The lower edge of the cutting blade 13 is covered with a movable cover 15. The movable cover 15 is supported in a manner rotatable substantially about a rotation center 13a of the cutting blade 13 with respect to the stationary cover 14. The movable cover 15 is open to uncover the edge of the cutting blade 13 when rotated clockwise in FIG. 1. The movable cover 15 is closed to cover the edge of the cutting blade 13 when rotated counterclockwise in FIG. 1. The movable cover 15 is urged in the closing direction by a tension spring (not shown).

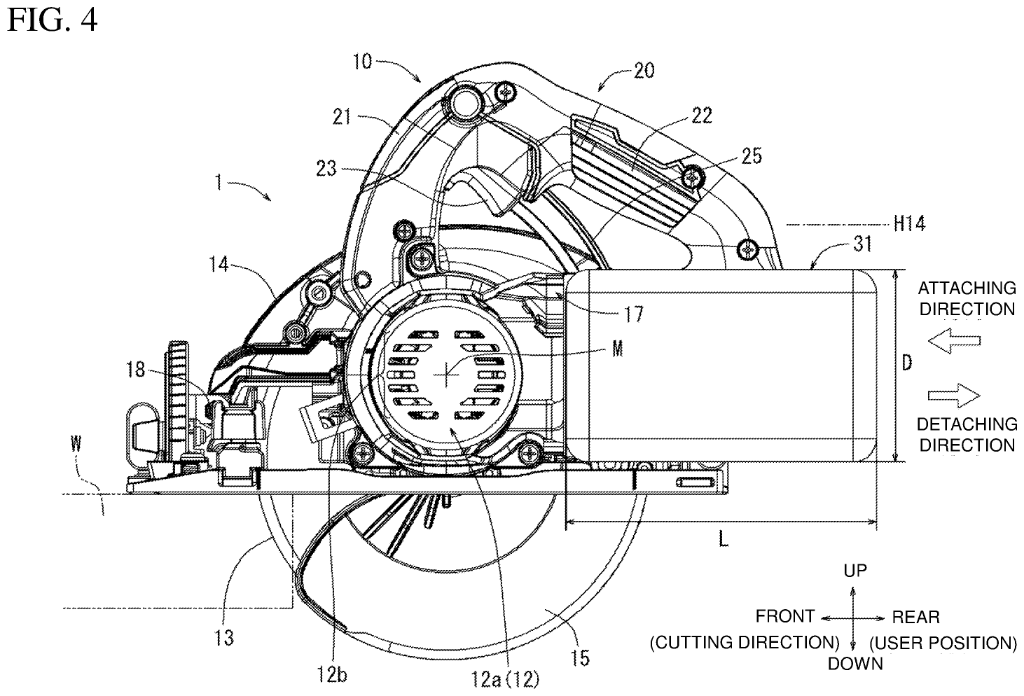

The stationary cover 14 has a reduction gear unit 16 on its left. The reduction gear unit 16 receives, on its left, a cylindrical motor housing 12a protruding leftward. The motor housing 12a accommodates the electric motor 12. The electric motor 12 is mounted to have a motor axis M in the right-left direction. As shown in FIG. 4, the motor housing 12a has, on an end face opposite to the cutting blade 13 (left end face), an inlet 12b for drawing in outside air (motor cooling air). The outside air drawn in through the inlet 12b cools the electric motor 12.

A battery attachment base 17 extends rearward from the rear of the motor housing 12a. The battery attachment base 17, which is a substantially flat plate, is placed to have the thickness direction being the right-left direction. A loop handle unit 20 extends across an area around the joint between the motor housing 12a and the reduction gear unit 16 and an area around the rear upper surface of the battery attachment base 17.

The handle unit 20 includes a standing portion 21 and a handle 22. The standing portion 21 extends upward from near the joint between the motor housing 12a and the reduction gear unit 16. The handle 22 extends rearward and downward from an upper portion of the standing portion 21. The handle 22 has a rear portion joined to near the rear upper surface of the battery attachment base 17. A trigger switch lever 23 is placed on the lower surface near the joint between the standing portion 21 and the handle 22. The user grips the handle 22 and moves the portable cutting machine 1, and pulls the switch lever 23 to start the electric motor 12.

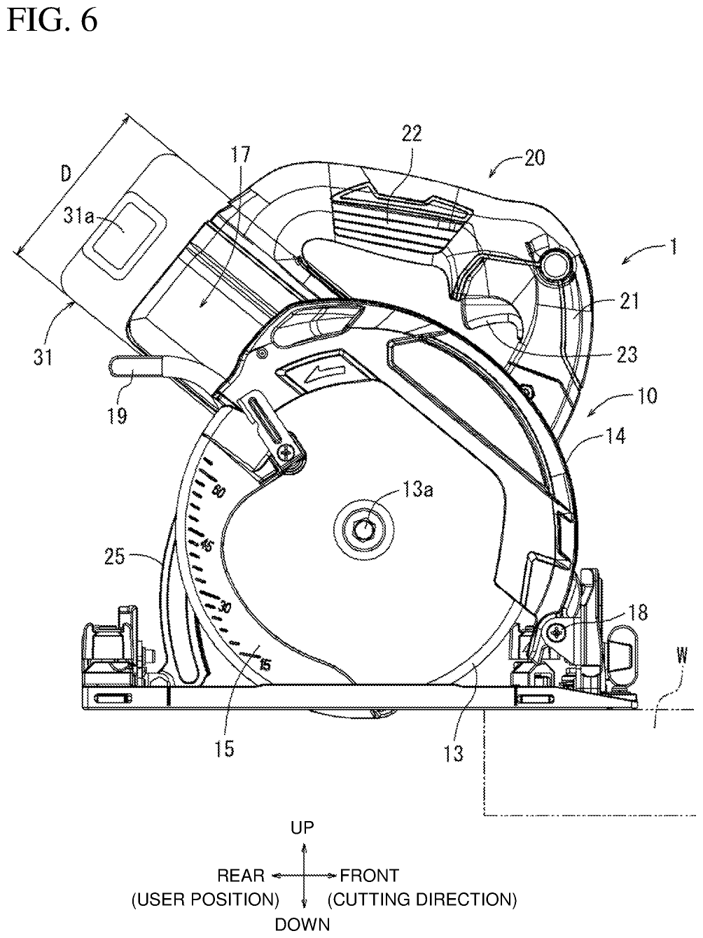

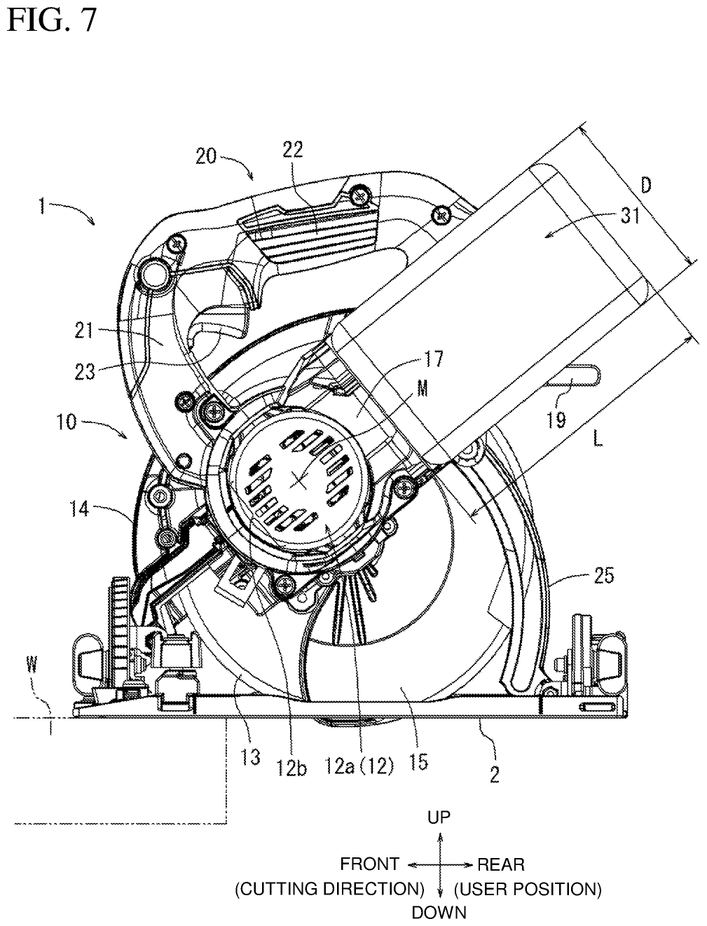

The cutting machine body 10 is supported by a vertical swing support shaft 18 in a vertically swingable manner with respect to the base 2. In FIGS. 6 and 7, the cutting machine body 10 is swung to the upper limit about the vertical swing support shaft 18. The vertical swing position of the cutting machine body 10 is changed with respect to the base 2 to change the degree by which the cutting blade 13 protrudes from the lower surface of the base 2. This adjusts the depth of cutting into the workpiece W. In FIG. 1, the cutting machine body 10 is swung to the lower limit with respect to the base 2 to maximize the cutting depth.

The vertical swing position of the cutting machine body 10 with respect to the base 2 is locked by rotating a lock lever 19 on the rear to the lock position. The lock lever 19 including a flat plate is located parallel to the cutting blade 13. The lock lever 19 protrudes rearward. The base 2 has, on its rear upper surface, an arc-shaped depth guide 25 standing upward. The depth guide 25 guides the vertical swing of the cutting machine body 10 at the rear.

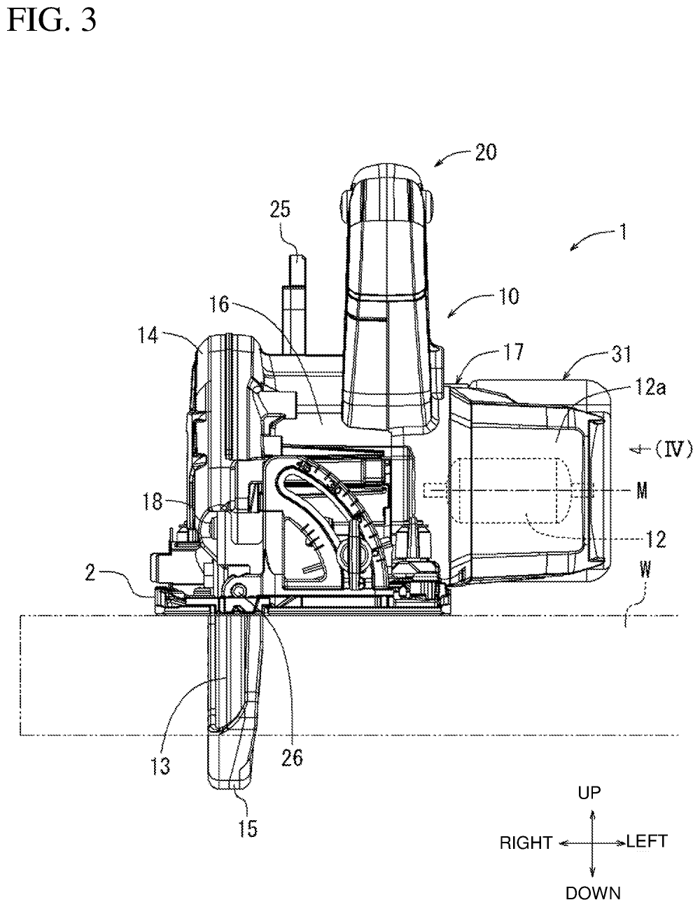

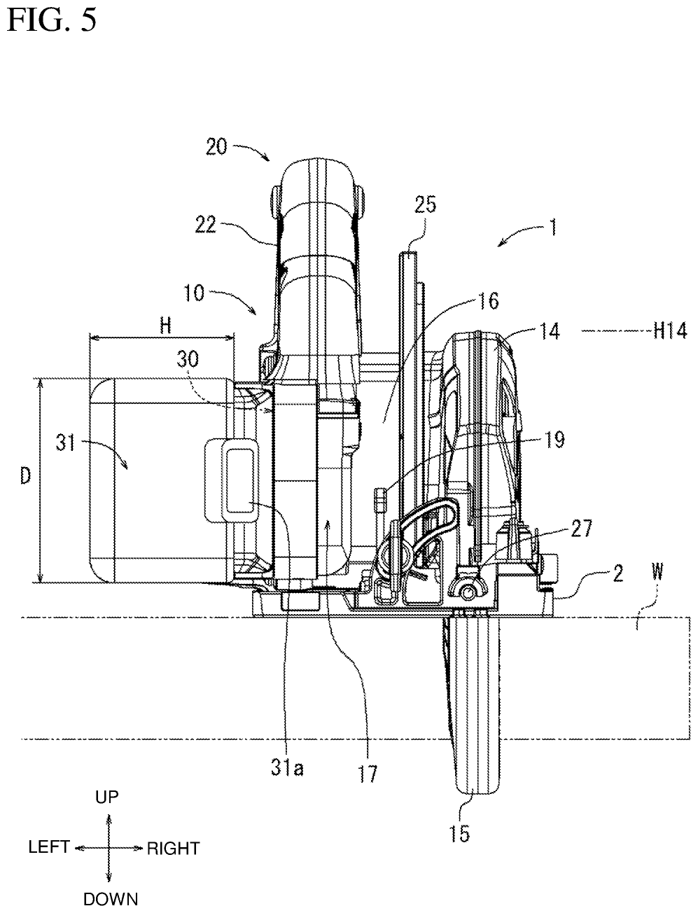

The cutting machine body 10 is supported to be laterally tiltable with respect to the base 2 with lateral tilt support shafts 26 and 27 at the front and the rear. FIG. 3 shows the lateral tilt support shaft 26 at the front. FIG. 5 shows the lateral tilt support shaft 27 at the rear. The lateral tilt support shafts 26 and 27 at the front and the rear are coaxial. Adjusting the lateral tilt position of the cutting machine body 10 using the lateral tilt support shafts 26 and 27 allows the cutting blade 13 to obliquely cut into the workpiece W to perform diagonal cutting.

The battery attachment base 17 is located behind the motor housing 12a. As shown in FIG. 2, the battery attachment base 17 is located opposite to the stationary cover 14 with respect to the handle unit 20 (opposite to the cutting blade 13). The battery attachment base 17 has a battery attachment portion 30 on its left side. The battery attachment portion 30 can receive one battery pack 31.

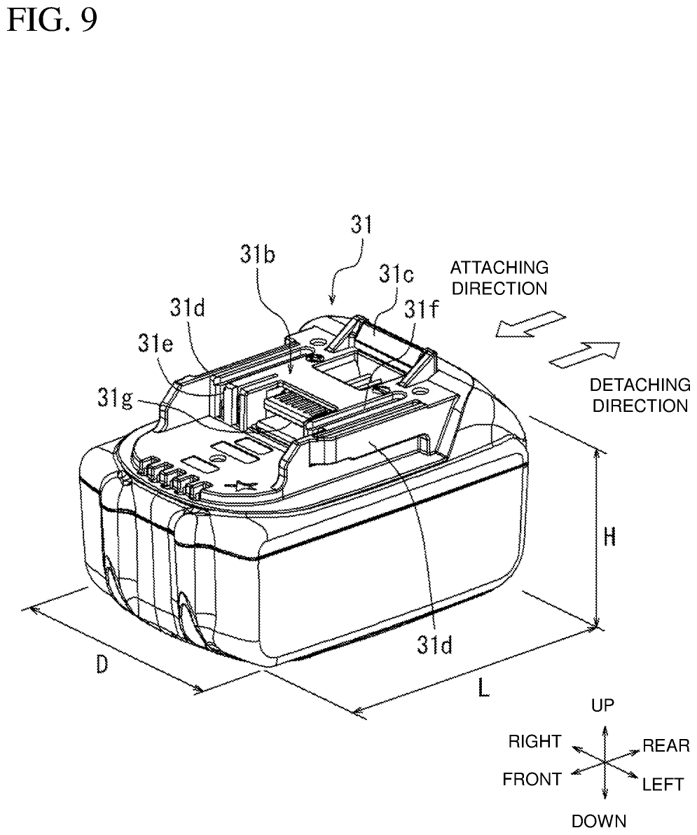

The battery pack 31 is a lithium-ion battery with an output of 18 V. The battery pack 31 detached from the battery attachment portion 30 may be charged with a separately prepared charger to allow repeated use. FIG. 9 shows the detached battery pack 31. The battery pack 31 is a substantially rectangular prism with a length L in the front-rear direction, a width D in the right-left direction, and a height H in the vertical direction. The length L, width D, and height H have the relationship written as L>D>H. Rails are long enough to maintain firm attachment. Thus, the length L is the largest. Terminals and the rails are located in parallel. Thus, the width D is the second largest. The height H is relatively flexible, but is the smallest in the present embodiment.

The battery pack 31 has six surfaces, the front, rear, right, left, upper, and lower surfaces. The upper surface in the figure is the connecting surface 31b that connects to the battery attachment portion 30. The connecting surface 31b has a larger area than any other side surfaces. The connecting surface 31b receives a pair of right and left rails 31d extending in the front-rear direction. The connecting surface 31b has positive and negative terminal slots 31e and 31f between the right and left rails 31d. The connecting surface 31b has a signal terminal slot 31g between the positive and negative terminal slots 31e and 31f.

The connecting surface 31b has a lock tab 31c at its rear. The lock tab 31c is urged toward its protruding end (lock position) by a spring. An unlock button 31a is located behind the lock tab 31c. The unlock button 31a is not shown in FIG. 9. Pressing the unlock button 31a lowers the lock tab 31c to the unlock position against the urging force of the spring. FIG. 9 shows the battery pack 31 alone, which is defined by referring to the front-rear, right-left, and vertical directions in a specific manner. The connecting surface 31b is the upper surface, the attaching direction is forward, and the detaching direction is rearward. The right-left direction is defined with the right and the left as viewed in the attaching direction.

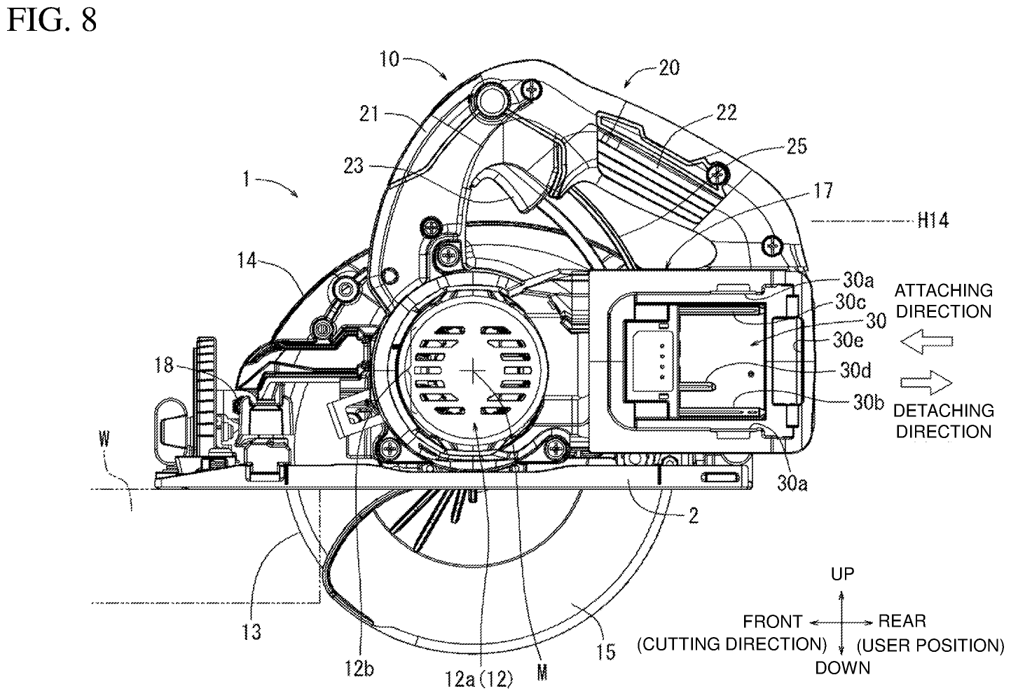

FIG. 8 shows the battery attachment portion 30 with the battery pack 31 detached. The battery attachment portion 30 has a pair of upper and lower rail receivers 30a. The upper and lower rail receivers 30a are parallel to each other and extend in the front-rear direction. The battery pack 31 may be attached to or detached from the battery attachment portion 30 by engaging the rails 31d with the upper and lower rail receivers 30a and then sliding the battery pack 31 forward or rearward. The battery pack 31 is attached by sliding it forward with respect to the battery attachment portion 30 as indicated by a solid-white arrow in FIG. 8. In contrast, the battery pack 31 is detached from the battery attachment portion 30 by sliding it rearward.

Positive and negative power terminals 30b and 30c are located between the upper and lower rail receivers 30a. A single signal terminal 30d is located between the positive and negative power terminals 30b and 30c. The battery attachment portion 30 has a tab engaging portion 30e that is engageable with the lock tab 31c of the battery pack 31. When the battery pack 31 is slid forward and then attached to the battery attachment portion 30, the lock tab 31c is engaged with the tab engaging portion 30e, thus locking the attachment of the battery pack 31 to the battery attachment portion 30. The battery pack 31 has the unlock button 31a on its rear as shown in FIG. 1. Pressing the unlock button 31a retracts the lock tab 31c to be disengaged from the tab engaging portion 30e. This allows the battery pack 31 to slide rearward and to be detached from the battery attachment portion 30.

The battery pack 31 is slid forward in a posture with the connecting surface 31b facing rightward (in a sideways posture) to be attached to the battery attachment portion 30. Thus, when the battery pack 31 is attached, the width D is in the vertical direction as shown in FIG. 1. In the same manner, as shown in FIG. 2, the length L is in the front-rear direction, and the height H is in the right-left direction.

As shown in FIGS. 2 and 3, the battery pack 31 attached in the sideways posture is positioned appropriately in the right-left direction of the battery attachment portion 30 without extending from the left end of the motor housing 12a. The battery pack 31 does not protrude leftward from the electric motor 12. This structure downsizes the portable cutting machine 1 in the lateral direction (right-left direction).

In FIG. 2, the broken line indicates a battery pack with a larger height H. For this large battery pack as well, the battery pack can simply have a larger dimension leftward as shown in the figure, and can avoid interference with the base, without increasing the height of the handle. As described above, two types of battery packs with different heights H may be attached to the battery attachment portion 30. The motor housing 12a may protrude sideward opposite to the cutting blade 13 with respect to the handle unit 20 farther than two types of battery packs 31 with different heights that are attachable to the battery attachment portion 30. In the present embodiment, the connecting surface 31b is perpendicular to the base surface. When the connecting surface 31b tilts rightward or leftward at an angle of about 10 degrees or less as viewed from the rear, this structure can still produce the same advantageous effects.

As shown in FIGS. 1, 4, and 5, the battery pack 31 is appropriately positioned in the height direction of the battery attachment portion 30 within a height H14 of the upper end of the stationary cover 14 covering the cutting blade 13. In other words, the stationary cover 14 has its upper end located above the battery pack 31. The attached battery pack 31 does not protrude upward from the upper end of the stationary cover 14. This structure downsizes the portable cutting machine 1 in the vertical direction and improves the operability of the portable cutting machine 1.

Further, the battery pack 31 is appropriately positioned in the vertical direction of the battery attachment portion 30 to be sufficiently below the handle unit 20, or more specifically, below the handle 22. The battery pack 31 is not obstructive when the handle 22 is to be gripped or is being gripped. This improves the operability of the portable cutting machine 1. As shown in FIGS. 1 and 4, the handle 22 has a lower portion substantially at the height H14 of the upper end of the stationary cover 14. The battery pack 31 is attached below the handle 22 and below the height H14 of the upper end of the stationary cover 14.

Further, the battery pack 31 is appropriately positioned in the front-rear direction of the battery attachment portion 30 to have its rear end protruding rearward from the rear end of the handle unit 20. This structure efficiently uses a space available behind the handle unit 20 for attaching a larger battery pack 31.

The portable cutting machine 1 according to the present embodiment can receive the battery pack 31 attached in a posture with the connecting surface 31b (upper surface) facing sideward. In other words, the battery pack 31 is attached to have the height H protruding leftward. This structure allows a battery pack 31 with a large height H to be attached without increasing the height of the handle unit 20.

When the battery pack 31 is attached, the height H is the dimension protruding sideward from the handle unit 20. Thus, the height position of the handle unit 20 can be determined independently of the height H of the battery pack 31. This allows a large battery pack 31 to be attachable without providing a large attachment space immediately below the handle unit, and increases the flexibility in the position of the handle unit 20 in the vertical direction.

The battery pack 31 attached in the sideways posture is positioned without extending from the left end of the motor housing 12a. This downsizes the portable cutting machine 1 in the lateral direction (right-left direction).

The battery pack 31 is attached within the height H14 of the upper end of the stationary cover 14 covering the cutting blade 13. This downsizes the portable cutting machine 1 in the vertical direction, thus maintaining the operability of the portable cutting machine 1.

The battery pack 31 is attached below the handle unit 20, or more specifically, below the handle 22. In other words, the handle 22 is located above the battery pack 31. The battery pack 31 is thus not obstructive when the handle 22 is to be gripped or is being gripped, enabling the handle unit 20 to be gripped easily.

The battery pack 31 is attached to protrude rearward from the handle unit 20. In other words, the battery attachment portion 30 receives the battery pack 31 attached to have its rear end protruding rearward from the handle unit 20. A space available behind the handle unit 20 can be used efficiently.

### Second Embodiment

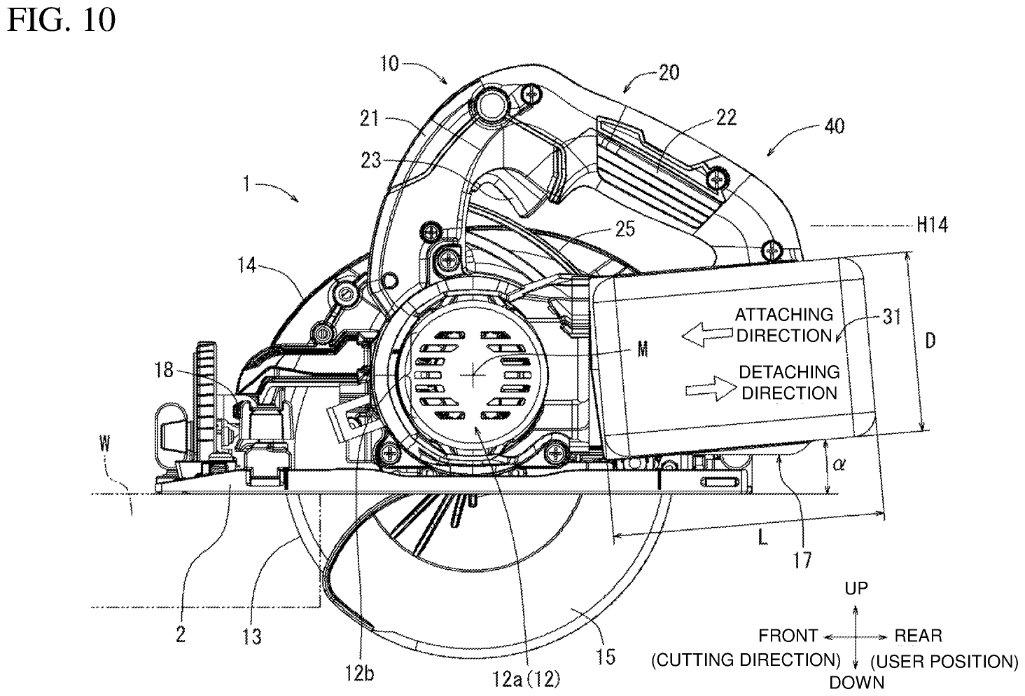

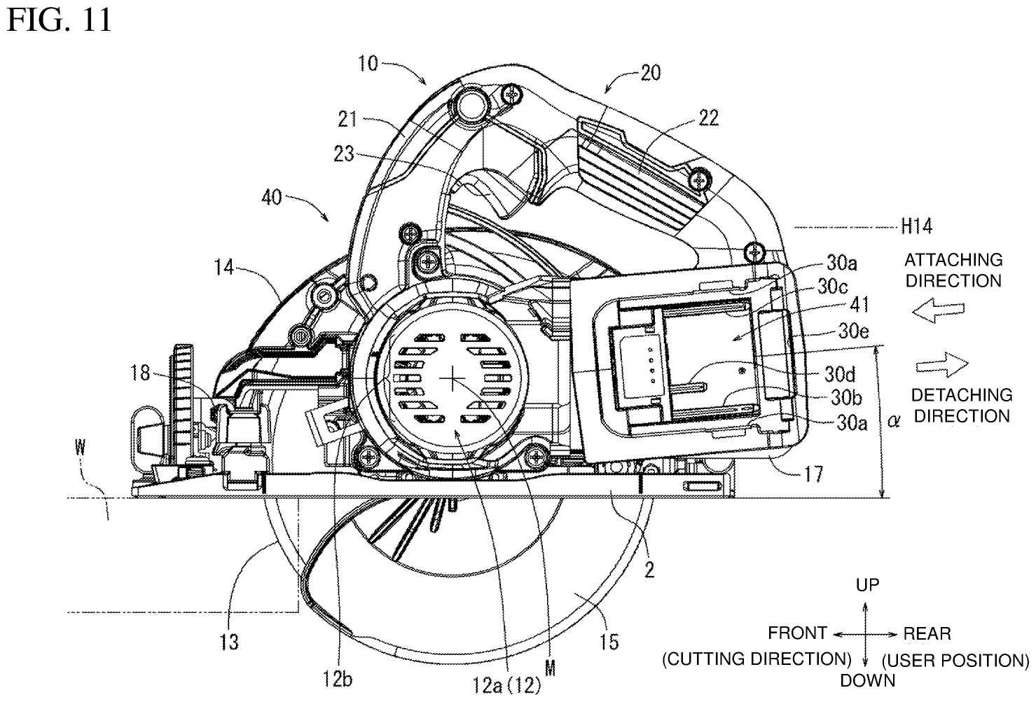

A portable cutting machine 40 according to a second embodiment will now be described with reference to FIGS. 10 and 11. The portable cutting machine 40 according to the present embodiment differs from the first embodiment in the direction in which the battery pack 31 is slid when attached to and detached from a battery attachment portion 41. The components and the structures that are the same as those in the first embodiment will be given the same reference numerals, and will not be described.

The sliding direction for attachment to and detachment from the battery attachment portion 30 in the first embodiment is parallel to the lower surface of the base 2 when the cutting machine body 10 is placed at the lowest position to maximize the cutting depth as shown in FIG. 8. In contrast, the sliding direction for attachment to and detachment from the battery attachment portion 41 in the second embodiment forms an angle α with the lower surface of the base 2 (tilts downward toward the front, or in the direction that causes a rear portion to move upward) while the cutting depth is maximized as shown in FIG. 11. The forward tilt angle α is about 5 degrees. The forward tilt angle α may be larger to still allow, for example, easy grip of the handle unit 20. For example, the forward tilt angle α may be set in a range of about 10 to 30 degrees to further improve the operability for the attachment and detachment.

The sliding direction for attaching and detaching the battery pack 31 forms an angle tilting forward with the lower surface of the base 2. This allows the battery pack 31 to be slid in the attaching direction or the detaching direction by the wrist of a hand gripping the battery pack 31 with a smaller effort as well as in a more comfortable posture with reduced twisting. This improves the operability for the attachment and detachment.

In the present embodiment as well, the battery pack 31 is attached in the sideways posture to the battery attachment portion 41 located on the left of the handle unit 20. In the same manner as in the first embodiment, the battery pack 31 with a larger height H can be attached while allowing the handle unit to be gripped easily.

### Third Embodiment

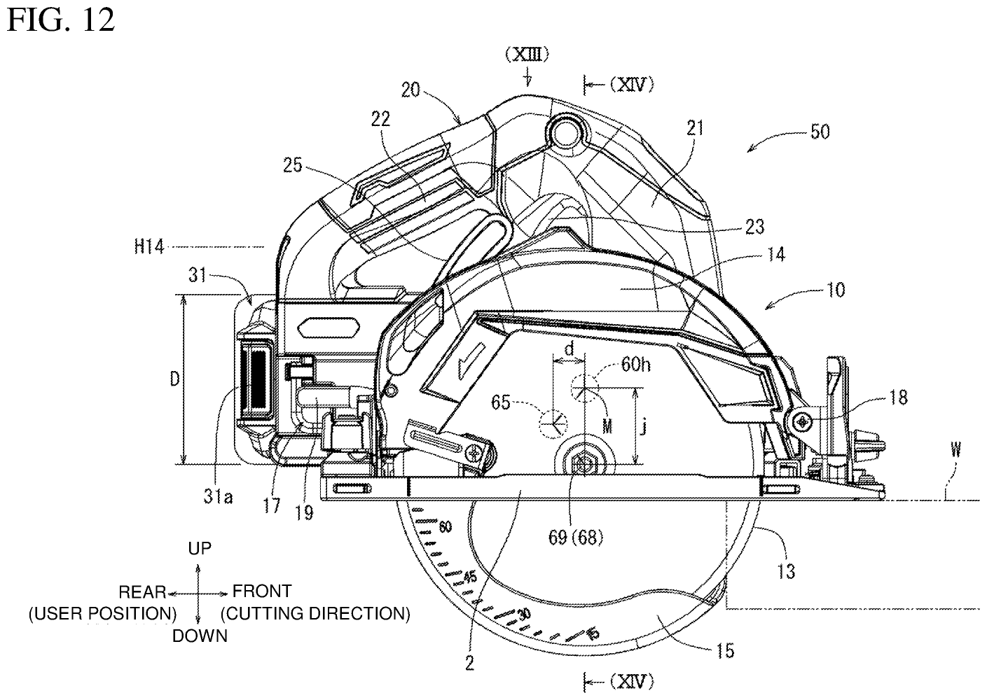

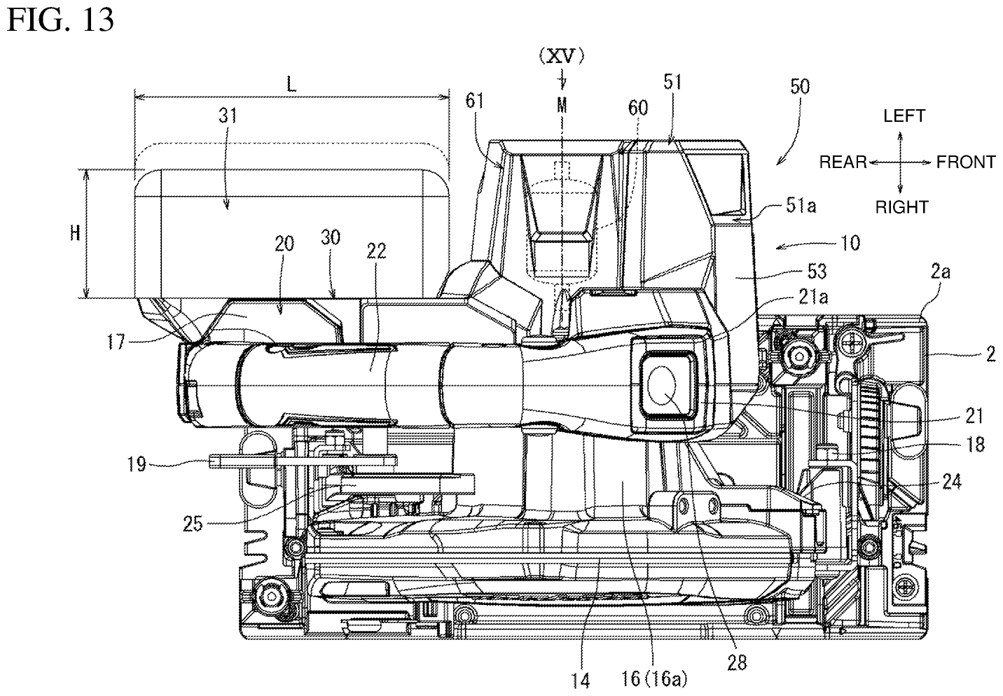

A portable cutting machine 50 according to a third embodiment will now be described with reference to FIGS. 12 to 15. The portable cutting machine 50 according to the present embodiment is mainly characterized by the position of a controller 52 for controlling the operation of an electric motor 60. The battery pack 31 is attached in a posture with the connecting surface 31b facing sideward (in the sideways posture) in the same manner as in the first and second embodiments. The components and the structures that are the same as those in the first and second embodiments will be given the same reference numerals, and will not be described. As indicated by the broken line in FIG. 13, either of the two types of battery packs 31 with different heights H may be attached in the sideways posture to the battery attachment portion 30 of the portable cutting machine 50 according to the present embodiment.

A portable cutting machine 50 according to the present embodiment includes a brushless motor as the electric motor 60. The electric motor 60 is accommodated in a cylindrical motor housing 61. The motor housing 61 is joined to the reduction gear unit 16 located on the left of the stationary cover 14 in the same manner as in the first embodiment. In other words, the electric motor 60 is located along the motor axis M extending in the right-left direction.

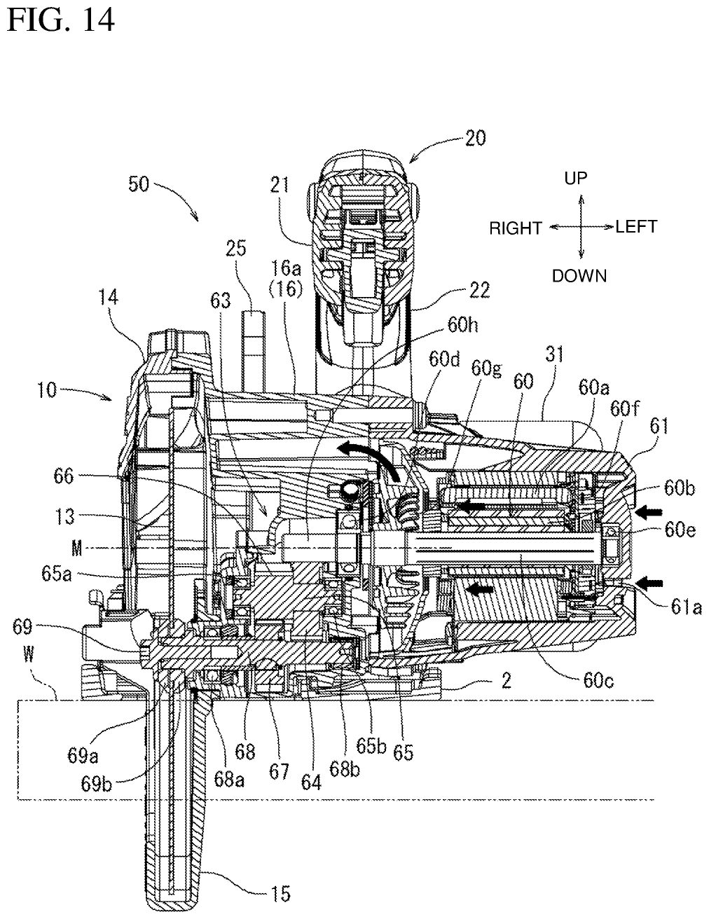

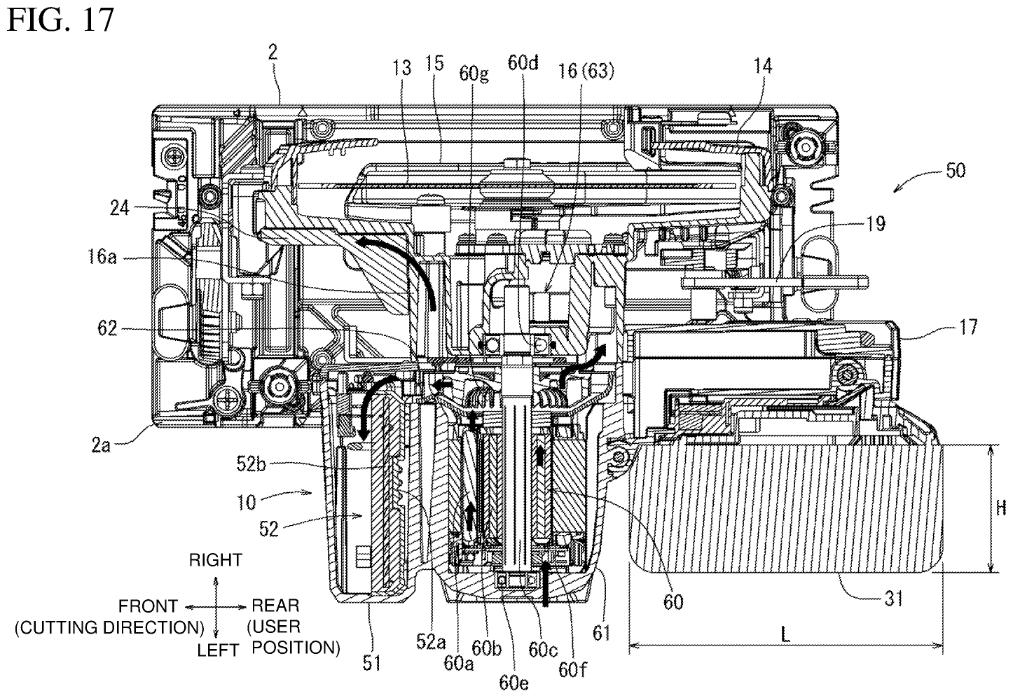

FIGS. 14 and 17 show the electric motor 60 in detail. The electric motor 60 includes a cylindrical stator 60a and a rotor 60b. The stator 60a is fixed along the inner peripheral surface of the motor housing 61. The rotor 60b is supported inside the stator 60a in a rotatable manner. The rotor 60b is integral with a motor shaft 60c. The motor shaft 60c is supported by a right bearing 60d and a left bearing 60e in a rotatable manner. The rotational axis of the motor shaft 60c is the motor axis M. The right bearing 60d is held on the reduction gear unit 16. The left bearing 60e is held on the left end of the motor housing 61.

The stator 60a has a disc-shaped sensor board 60f mounted along its left end. The sensor board 60f detects the rotational position of the rotor 60b. The motor shaft 60c has a cooling fan 60g mounted between the rotor 60b and the right bearing 60d. The cooling fan 60g and the motor shaft 60c rotate integrally.

The motor housing 61 has an inlet 61a in its left end face for drawing in motor cooling air. When the electric motor 60 starts rotating the cooling fan 60g, the outside air is drawn in through the inlet 61a. The outside air drawn in through the inlet 61a cools the electric motor 60. The thick bold arrows in FIGS. 14 and 17 indicate the flow of the motor cooling air. The motor cooling air drawn in through the inlet 61a flows rightward and then into a controller housing 51 (described below) through an air vent 62. The air vent 62 is located adjacent to the cooling fan 60g and in front of the right end of the motor housing 61.

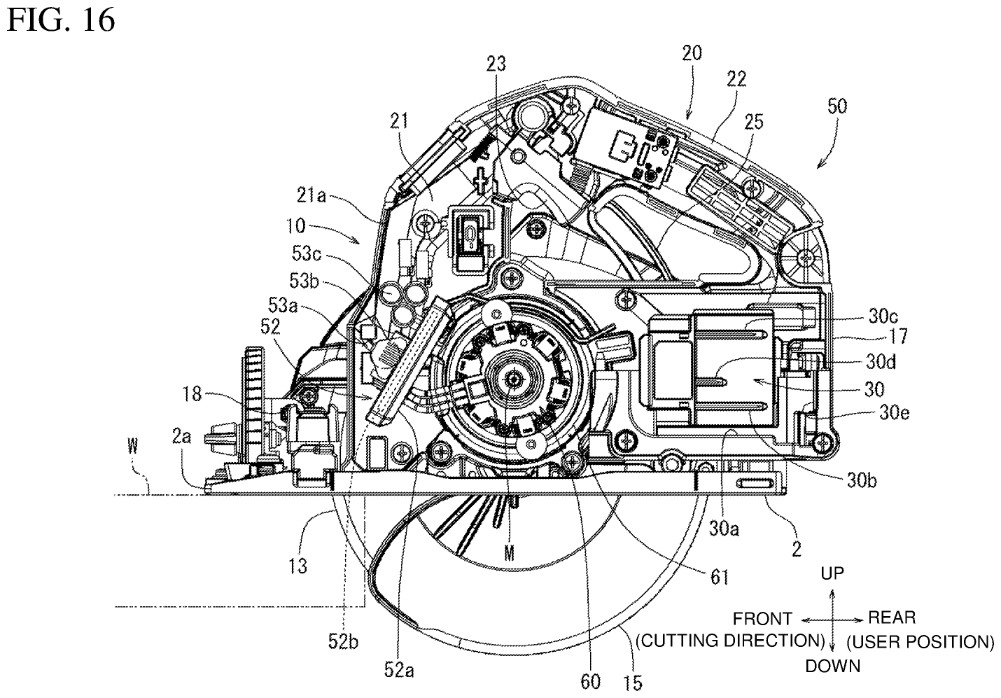

The portable cutting machine 50 according to the present embodiment includes the controller housing 51 in front of the motor housing 61. The controller housing 51 accommodates the controller 52. As shown in FIGS. 16 and 17, the controller 52 is a substantially flat plate including a control board 52b for mainly controlling the electric motor 60 accommodated in a rectangular shallow case 52a, which is formed by aluminum die casting, and molded with resin.

The control board 52b receives a control circuit, a drive circuit, an automatic stop circuit, and other circuits. The control circuit includes a microcomputer, and transmits a control signal based on information about the rotational position of the rotor 60b detected by the sensor board 60f. The drive circuit includes a field-effect transistor (FET), and switches a current flowing through the electric motor 60 in response to the control signal received from the control circuit. The automatic stop circuit and other circuits cut power supply to the electric motor 60 to prevent overdischarge or overcharge based on the detection result of the status of the battery pack 31.

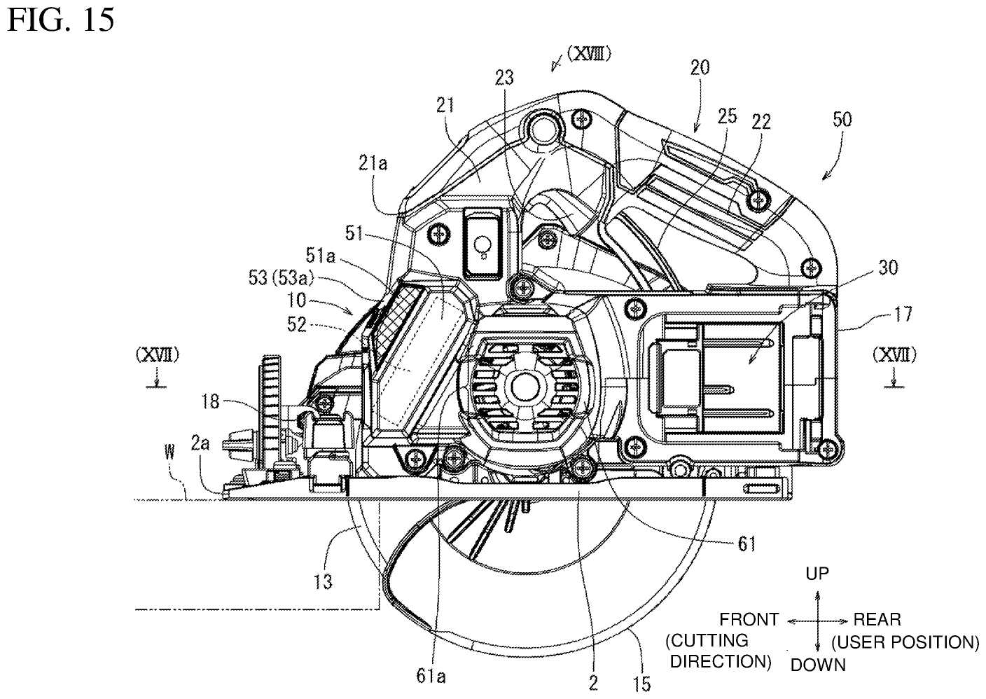

The controller 52 is in a forward-tilt posture having its lower portion positioned forward inside the controller housing 51 as shown in the figure. Thus, the controller housing 51 also tilts to have its lower portion positioned forward and its upper portion joined to the front of the motor housing 61 as shown in FIG. 15. The air vent 62 is located at the joint between the upper portion of the controller housing 51 and the front of the motor housing 61. The motor housing 61 and the controller housing 51 communicate with each other through the air vent 62.

The motor cooling air drawn by the cooling fan 60g into the motor housing 61 flows into the controller housing 51 through the air vent 62 to cool the controller 52, as indicated by the thick bold arrows in FIGS. 14 and 17. The flowing cooling air cools the heat source such as an FET mounted on the control board 52b. The motor cooling air partially does not flow into the controller housing 51 but flows into a blower duct 24 extending forward along the vertical wall of the stationary cover 14 near the motor, and then is discharged forward from the stationary cover 14 as exhaust air. The motor cooling air may partially flow into the reduction gear unit 16 and then may be discharged inside the stationary cover 14.

The reduction gear unit 16, which is a gear housing 16a accommodating a gear train 63, reduces the rotational output from the electric motor 60 in two steps, and then transmits the resultant output to an output shaft 68. FIG. 14 shows the reduction gear unit 16 in detail. The motor shaft 60c has its right end located inside the gear housing 16a. The motor shaft 60c has a driving gear unit 60h mounted on its right end. The driving gear unit 60h is meshed with a first driven gear 64. The first driven gear 64 is mounted on the left of a countershaft 65. The countershaft 65 is supported on the gear housing 16a with a right bearing 65a and a left bearing 65b in a rotatable manner. The countershaft 65 has a second driven gear 66 located on the right of the first driven gear 64. The first and second driven gears 64 and 66 rotate integrally with the countershaft 65.

The second driven gear 66 is meshed with an output gear 67. The output gear 67 is integral with the output shaft 68. The output shaft 68 is supported on the lower portion of the gear housing 16a with a right bearing 68a and a left bearing 68b in a rotatable manner. The output shaft 68 has its right end protruding into the stationary cover 14. The cutting blade 13 is attached to the right end of the output shaft 68. The cutting blade 13 held between an outer flange 69a and an inner flange 69b is attached to an axial end of the output shaft 68 with a cutting blade mounting screw 69 being screwed.

The countershaft 65 shifts rearward by a distance d from a line connecting the rotational axis of the motor shaft 60c (motor axis M) and the rotational axis of the output shaft 68 (rotation center of the cutting blade 13) as shown in FIG. 12. This reduces a vertical axis-to-axis distance j between the motor shaft 60c and the output shaft 68 to lower the motor axis M. This structure downsizes the product.

The controller housing 51 has an electric component compartment 53 located in its front portion as shown in FIGS. 13 and 15. The electric component compartment 53 provides an accommodating space 53a that expands in front of the controller 52. The accommodating space 53a accommodates various electric components, such as an FET, a capacitor 53b, and wiring 53c as shown in FIG. 16. The handle unit 20 has a switch button 28 on its front face for switching the operating mode of the portable cutting machine 50 as shown in FIG. 13. Pressing the switch button 28 switches the mode between a constant speed mode and an automatic transmission mode. In the automatic transmission mode, the rotation speed is switched automatically between a high-speed rotation with low torque and a low-speed rotation with high torque in accordance with increase in a load. Two lamps indicating the mode switching status are provided on the front face of the handle unit 20 adjacent to the switch button 28. The two lamps are located along a guideline seen by the operator and thus the guideline is highly visible.

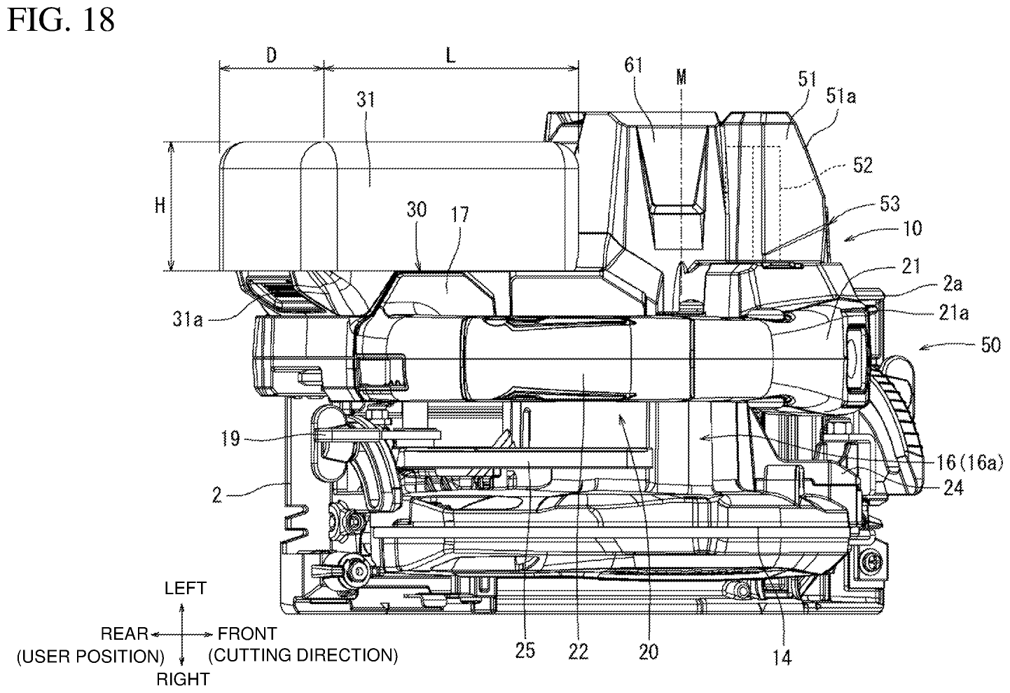

The controller housing 51 has a ground contact face 51a on an upper surface of its left portion for three-point inverted placement. The ground contact face 51a is a hatched area enclosed with a bold line in FIG. 15. The ground contact face 51a slopes downward toward the front and toward the left. More specifically, the ground contact face 51a is a flat slope toward the front and the left. FIG. 18, as viewed in the direction of arrow (XVIII) in FIG. 15, shows the portable cutting machine 50 viewed from the ground contact face 51a for inverted placement in the plane direction. The direction of arrow (XVIII) in FIG. 15 is substantially the same as the direction in which the controller 52 extends (plane direction). In other words, the ground contact face 51a is a flat surface that slopes from two straight lines (edge lines) substantially parallel to the extending direction of the controller 52.

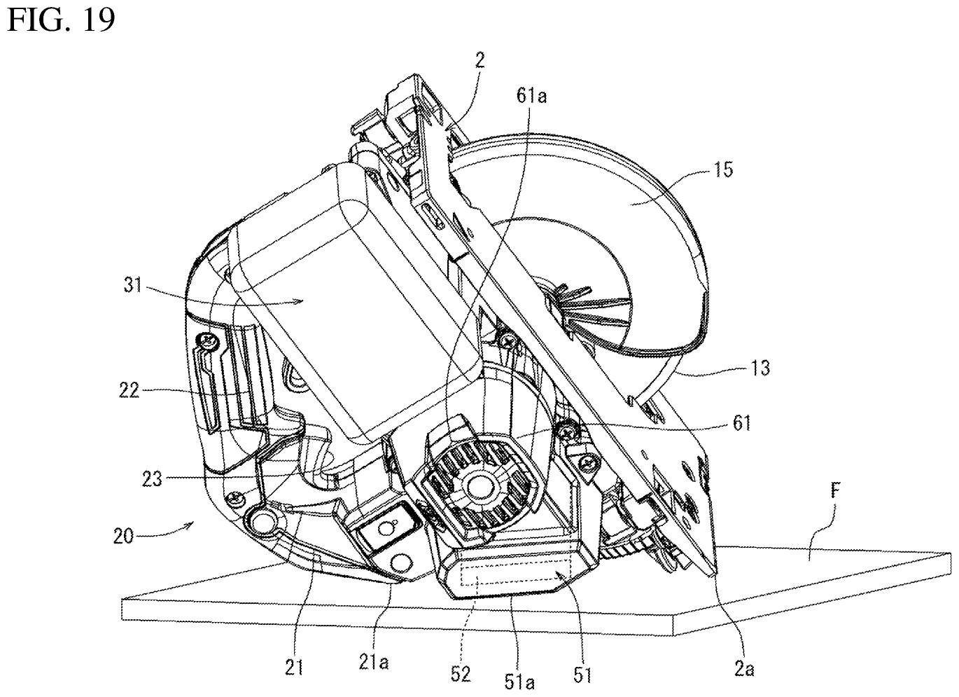

As shown in FIG. 19, the portable cutting machine 50 may be stably placed upside down in an inverted posture on its three portions, or specifically the ground contact face 51a, a left front corner 2a of the base 2, and a front end 21a of the standing portion 21 of the handle unit 20, in contact with a placement surface F. In the inverted posture, the lower surface of the base 2 faces upward and the cutting blade 13 covered with the movable cover 15 protrudes upward as shown in the figure.

In the inverted posture, the handle 22 is appropriately upward away from the placement surface F. This allows the operator to, for example, place the portable cutting machine 50 upside down on the placement surface F to temporarily stop cutting while gripping the handle 22.

In the inverted posture, the cutting blade 13 faces upward and thus is prevented from damaging the placement surface F. Additionally, the handle 22 remains easily gripped, and thus allows the work to be easily stopped or resumed. As described above, for example, the controller housing 51 has the ground contact face 51a for three-point inverted placement to allow the portable cutting machine 50 to be stably placed upside down in the inverted posture. This improves the operability of the portable cutting machine 50.

The portable cutting machine 50 according to the present embodiment can receive the battery pack 31 attached in a posture with the upper surface (connecting surface 31b) facing sideward, and thus has the same advantageous effects as in the first embodiment.

The portable cutting machine 50 according to the present embodiment includes the controller 52 for controlling the electric motor 60 placed efficiently in an unused space in front of the motor housing 61.

More specifically, the controller 52 is in a forward-tilt posture tilting downward toward the front inside the controller housing 51, and the controller housing 51 has an upper portion joined to the motor housing 61. This structure places the controller 52 in a small space in the height direction, and allows the controller housing 51 to have a small height and thus an increased rigidity.

The portable cutting machine 50 according to the present embodiment includes the electric component compartment 53 placed in front of the controller housing 51. The electric component compartment 53 includes its upper end lower than an upper end of the controller housing 51. The electric component compartment for a capacitor and wiring may thus fit in a small space in front of the controller housing 51.

The portable cutting machine 50 according to the present embodiment includes an end of the controller housing 51 opposite to the cutting blade 13 (left end) flush with an end of the motor housing 61 opposite to the cutting blade 13. The ends of the controller housing 51 and the motor housing 61 may both come in contact with the ground. The portable cutting machine 50 can thus be more stably placed with the cutting blade 13 located upward and parallel to the placement surface F. This facilitates maintenance such as replacing the cutting blade.

The portable cutting machine 50 according to the present embodiment has the ground contact face 51a for three-point inverted placement on the front surface of the controller housing 51. The ground contact face 51a, the left front corner 2a of the base 2, and the front end 21a of the handle unit 20 may together stably place the portable cutting machine 50 substantially upside down in the three-point inverted posture. The portable cutting machine 50 may be stably placed in the inverted postured as described, and thus is prevented from damaging the placement surface and other components in, for example, a temporary stop of the work. The portable cutting machine 50 can thus temporarily wait on the placement surface. Further, the handle 22 may be easily gripped when the work is to be resumed. This improves the operability of the portable cutting machine 50.

The ground contact face 51a for three-point inverted placement is a flat surface that slopes between two straight lines (edge lines) substantially parallel to the extending direction of the controller 52 in the present embodiment. However, any surface that slopes between different lines may be used as the ground contact face for three-point inverted placement. In other words, a corner or another portion of the controller housing may be partially cut to form a ground contact face, thus allowing three-point inverted placement without the use of, for example, legs separately provided. Although the left front corner 2a of the base 2 and the front end 21a of the handle unit 20 are in contact with the ground to achieve three-point inverted placement in the above example, other two portions may be in contact with the ground together with the ground contact face 51a.

Additional modifications may be added to the portable cutting machines 1, 40, and 50 according to the first to third embodiments described above. The structure for attaching the battery pack 31 and the placement of the controller 52 in the above embodiments may be used for a cutting machine including a rotary blade such as a saw blade and a diamond wheel or a reciprocating saw or a jigsaw that reciprocates a cutting blade, in addition to a portable cutting machine including a tipped saw as a cutting blade.

### REFERENCE SIGNS LIST

W workpiece
1 portable cutting machine (first embodiment)
2 base
2a left front corner
10 cutting machine body
12 electric motor
12a motor housing
12b inlet
M motor axis
13 cutting blade
13a rotation center
14 fixed cover
H14 height of upper end of stationary cover 14
15 movable cover
16 reduction gear unit
17 battery attachment base
18 vertical swing support shaft
19 lock lever
20 handle unit
21 standing portion
21a front end
22 handle
23 switch lever
24 blower duct
25 depth guide
26, 27 lateral tilt support shafts
28 switch button
30 battery attachment portion
30a rail receiver
30b, 30c positive and negative power terminals
30d signal terminal
30e tab engaging portion
31 battery pack (length L, width D, and height H)
31a unlock button
31b connecting surface
31c lock tab
31d rail
31e, 31f positive and negative terminal slots
31g signal terminal slot
40 portable cutting machine (second embodiment)
41 battery attachment portion
50 portable cutting machine (third embodiment)
51 controller housing
51a ground contact face
52 controller
52a case
52b control board
53 electric component compartment
53a accommodating space
53b capacitor
53c wiring
60 electric motor
60a stator
60b rotor
60c motor shaft
60d, 60e bearing
60f sensor board
60g cooling fan
60h driving gear unit
61 motor housing
61a inlet
62 air vent
63 gear train
64 first driven gear
65 countershaft
65a, 65b bearing
66 second driven gear
67 output gear
68 output shaft
68a, 68b bearing
69 cutting blade mounting screw
69a outer flange
69b inner flange
F placement surface

What is claimed is:

1. A portable cutting machine to which a battery pack having a connecting surface is attachable, the portable cutting machine comprising:
a base configured to come in contact with a workpiece;
a cutting machine body supported on an upper surface of the base, the cutting machine body including
a cutting blade protruding from a lower surface of the base to cut the workpiece,
an electric motor configured to drive the cutting blade, and
a handle unit grippable by a user; and
a battery attachment portion located opposite to the cutting blade with respect to the handle unit, the battery attachment portion being configured to receive the battery pack attachable by sliding in a posture with the connecting surface facing sideward.

2. The portable cutting machine according to claim 1, further comprising:
a motor housing accommodating the electric motor, the motor housing protruding sideward opposite to the cutting blade with respect to the handle unit farther than two types of battery packs with different heights that are attachable to the battery attachment portion.

3. The portable cutting machine according to claim 1, further comprising:
a cover covering the cutting blade, the cover having an upper end located above the battery pack.

4. The portable cutting machine according to claim 1, wherein
the handle unit includes a handle located above the battery pack.

5. The portable cutting machine according to claim 1, wherein
the battery attachment portion receives the battery pack attachable to have a rear end of the battery pack protruding rearward from a rear end of the handle unit.

6. The portable cutting machine according to claim 1, wherein
the battery attachment portion receives the battery pack attachable by sliding forward and downward.

7. The portable cutting machine according to claim 1, further comprising:
a controller located in front of a motor housing accommodating the electric motor and configured to control an operation of the electric motor.

8. The portable cutting machine according to claim 7, further comprising:
a controller housing accommodating the controller that tilts forward and downward in a forward-tilt posture,
wherein the controller housing includes an upper portion joined to the motor housing.

9. The portable cutting machine according to claim 8, further comprising:
an electric component compartment located in front of the controller housing,
wherein the electric component compartment includes an upper end lower than an upper end of the controller housing.

10. The portable cutting machine according to claim 8, wherein
the controller housing includes an end opposite to the cutting blade flush with an end of the motor housing opposite to the cutting blade.

11. The portable cutting machine according to claim 8, wherein
the controller housing includes a ground contact face, and
the ground contact face, the base, and the handle unit are configured to together place the portable cutting machine in an inverted posture.

12. The portable cutting machine according to claim 1, wherein
the battery attachment portion receives the battery pack attachable to have the connecting surface parallel to the cutting blade.

13. The portable cutting machine according to claim 1, wherein
the battery attachment portion receives the battery pack attachable to have the connecting surface located between a side surface of the handle unit and a side surface of the base.

14. The portable cutting machine according to claim 1, wherein
the handle unit includes a battery attachment base opposite to the cutting blade.

15. The portable cutting machine according to claim 14, wherein
the battery attachment base has a rear end flush with a rear end of the handle unit.

16. The portable cutting machine according to claim 1, further comprising:
a lock lever configured to lock a vertical swing position of the cutting machine body with respect to the base, the lock lever including a flat plate and located parallel to the cutting blade.

17. The portable cutting machine according to claim 16, wherein
the lock lever protrudes rearward.

18. The portable cutting machine according to claim 11, wherein
the ground contact face is a slope parallel to the controller.

19. The portable cutting machine according to claim 2, further comprising:
a cover covering the cutting blade, the cover having an upper end located above the battery pack.

20. The portable cutting machine according to claim 2, wherein
the handle unit includes a handle located above the battery pack.
